(19) United States
(12) Patent Application Publication
(10) Pub. No.: US 2026/0134159 A1
(43) Pub. Date: May 14, 2026

(54) Optimal Auto Rack Deployment Design In A Data Center

(71) Applicant: Oracle International Corporation, Redwood Shores, CA (US)

(72) Inventors: Krishna Chaitanya Sunkara, Morrisville, NC (US); Akshay Mahesh Bhusare, Austin, TX (US)

(73) Assignee: Oracle International Corporation, Redwood Shores, CA (US)

(21) Appl. No.: 19/175,789

(22) Filed: Apr. 10, 2025

Related U.S. Application Data
(60) Provisional application No. 63/720,657, filed on Nov. 14, 2024.

(51) Int. Cl. G06F 30/13; G06F 30/20; G06F 111/04

(52) U.S. Cl. CPC G06F 30/13; G06F 30/20; G06F 2111/04

(57) ABSTRACT

Techniques for generating a layout for computing equipment in a data center are disclosed. The system represents a physical environment as a layout polygon and obstacles within the physical environment as obstacle polygons. The system represents groupings of racks as pod polygons. The system executes a positioning algorithm to place pod polygons in the layout polygon. The initial layout is optimized according to layout criteria. The system determines if any of the pod polygons in the initial layout collide with an obstacle polygon. The system attempts to resolve the collision by moving the colliding pod polygons or removing racks from a pod polygon. The system generates a basket tray path that minimizes the length of the basket tray path while avoiding obstacles in the path.

### BENEFIT CLAIMS; RELATED APPLICATIONS; INCORPORATION BY REFERENCE

This application claims the benefit of U.S. Provisional Patent Application 63/720,657, filed Nov. 14, 2024, which is hereby incorporated by reference.

### TECHNICAL FIELD

The present disclosure relates to cloud computing data centers. In particular, the present disclosure relates to optimizing a layout of data center equipment in view of constraints in the physical environment of the data center.

### BACKGROUND

Cloud computing services operate large amounts of computing equipment, e.g., racks, in the physical environment of a data center. A cloud computing service attempts to fit as much computing equipment into the physical environment as possible to maximize use of the environment. However, the rooms in a data hall where the computing equipment will operate are usually not completely empty and may have multiple obstacles that interfere with the placement of the computing equipment, including support pillars, staircases, doors, and ventilation and plumbing fixtures. Arriving at a layout that optimizes the placement of the computing equipment can be challenging.

The approaches described in this section are approaches that could be pursued, but not necessarily approaches that have been previously conceived or pursued. Therefore, unless otherwise indicated, one should not assume that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment, and they mean at least one. In the drawings:

FIGS. 1-4 are block diagrams illustrating patterns for implementing a cloud infrastructure as a service system in accordance with one or more embodiments;

FIG. 5 is a hardware system in accordance with one or more embodiments;

FIG. 6 illustrates a system in accordance with one or more embodiments;

FIGS. 7A-B illustrate an example set of operations for generating a layout for a data center in accordance with one or more embodiments;

FIG. 8 illustrates an example set of operations for a positioning algorithm in accordance with one or more embodiments;

FIG. 9 illustrates an example set of operations for a collision avoidance algorithm in accordance with one or more embodiments;

FIGS. 10A-E illustrate an example of a layout in progress in accordance with one or more embodiments;

FIGS. 11A-B illustrate an example of a layout in progress with collision avoidance in accordance with one or more embodiments;

FIGS. 12A-B illustrate another example of a layout in progress with collision avoidance in accordance with one or more embodiments;

FIG. 13 illustrates an example of basket tray paths in accordance with one or more embodiments;

FIG. 14 illustrates a machine learning engine in accordance with one or more embodiments; and

FIG. 15 illustrates the operation of a machine learning engine in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. CLOUD COMPUTING TECHNOLOGY
3. COMPUTER SYSTEM
4. LAYOUT GENERATOR ARCHITECTURE
5. GENERATING A LAYOUT FOR A DATA CENTER
6. EXAMPLE EMBODIMENT
7. PRACTICAL APPLICATIONS, ADVANTAGES, AND IMPROVEMENTS
8. MACHINE LEARNING ARCHITECTURE
9. GENERATIVE MODELS
10. MISCELLANEOUS; EXTENSIONS

### 1. General Overview

One or more embodiments position server racks within a physical environment using a combination of a positioning algorithm and a collision avoidance algorithm. The positioning algorithm generates an initial layout. The collision avoidance algorithm iteratively modifies the layout generated by the positioning algorithm based on obstacles.

A system represents the physical environment of a data center as a layout polygon and obstacles within the physical environment as obstacle polygons. The system represents groupings of racks, referred to as pods, as pod polygons. The system executes a positioning algorithm to place pod polygons in the layout polygon in an initial layout that is optimized according to layout criteria. The system determines if any of the pod polygons in the initial layout collide with an obstacle polygon, indicating that a pod cannot be placed in the position of the obstacle. The system attempts to resolve the collision by moving the colliding pod polygons or removing racks from a pod polygon. The system generates a basket tray path that minimizes the length of the basket tray path while avoiding obstacles in the path.

One or more embodiments described in this Specification and/or recited in the claims may not be included in this General Overview section.

### 2. Cloud Computing Technology

Infrastructure as a Service (IaaS) is an application of cloud computing technology. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components; example services include billing software, monitoring software, logging software, load balancing software, clustering software, etc. Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and install enterprise software into that VM. Customers can then use the provider's services to perform various functions, including balancing network traffic, troubleshooting application issues, monitoring performance, and managing disaster recovery, etc.

In some cases, a cloud computing model will involve the participation of a cloud provider. The cloud provider may, but need not, be a third-party service that specializes in providing (e.g., offering, renting, selling) IaaS. An entity may also opt to deploy a private cloud, such that the entity becomes a provider of infrastructure services.

In some examples, IaaS deployment is the process of implementing a new application, or a new version of an application, onto a prepared application server or other similar device. IaaS deployment may also include the process of preparing the server (e.g., installing libraries, daemons, etc.). The deployment process is often managed by the cloud provider below the hypervisor layer (e.g., the servers, storage, network hardware, and virtualization). Thus, the customer may be responsible for handling (OS), middleware, and/or application deployment, such as on self-service virtual machines. The self-service virtual machines can be spun up on demand.

In some examples, IaaS provisioning may refer to acquiring computers or virtual hosts for use, even installing needed libraries or services on them. In most cases, deployment does not include provisioning, and the provisioning may need to be performed first.

In some cases, there are challenges for IaaS provisioning. There is an initial challenge of provisioning the initial set of infrastructure. There is an additional challenge of evolving the existing infrastructure (e.g., adding new services, changing services, removing services, etc.) after the initial provisioning is completed. In some cases, these challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on one another, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). In some embodiments, infrastructure and resources may be provisioned (manually, and/or using a provisioning tool) prior to deployment of code to be executed on the infrastructure. However, in some examples, the infrastructure that will deploy the code may first be set up. In some instances, the provisioning can be done manually, a provisioning tool may be utilized to provision the resources, and/or deployment tools may be utilized to deploy the code once the infrastructure is provisioned.

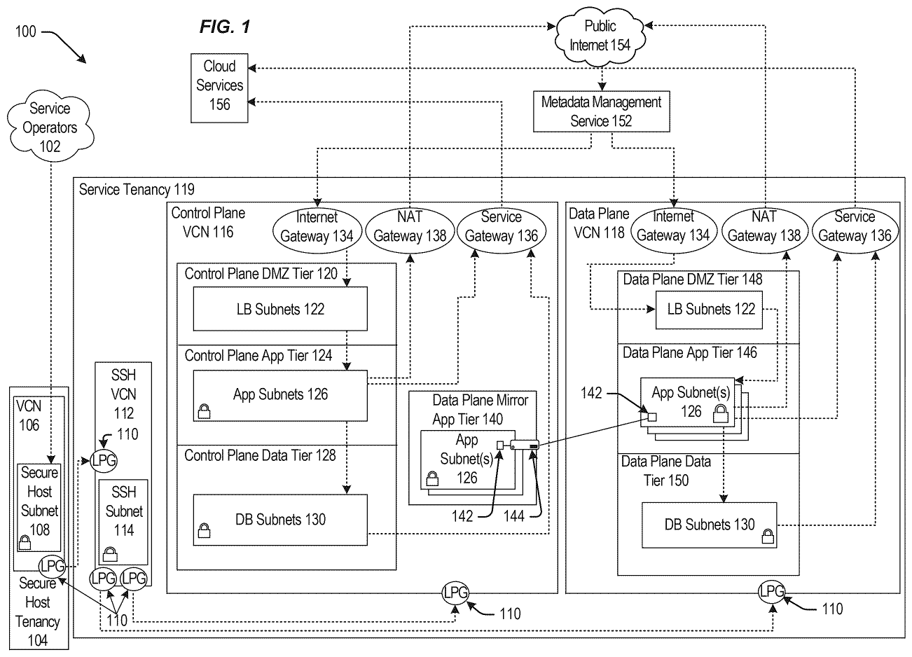

FIG. 1 is a block diagram illustrating an example pattern of an IaaS architecture 100 according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices, such as portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, including personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems such as Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116. The app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively couple to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way; the service gateway 136 can make API calls to cloud services 156, and cloud services 156 can send requested data to the service gateway 136. However, cloud services 156 may not initiate API calls to the service gateway 136.

In some examples, the secure host tenancy 104 can be directly connected to the service tenancy 119. The service tenancy 119 may otherwise be isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118. The control plane VCN 116 and the data plane VCN 118 may be contained in the service tenancy 119. This embodiment can enable isolation of networks that may prevent users or customers from interacting with other users', or other customers', resources. Also, this embodiment may allow users or customers of the system to store databases privately without needing to rely on public Internet 154 for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119. The service tenancy 119 may be isolated from public Internet 154.

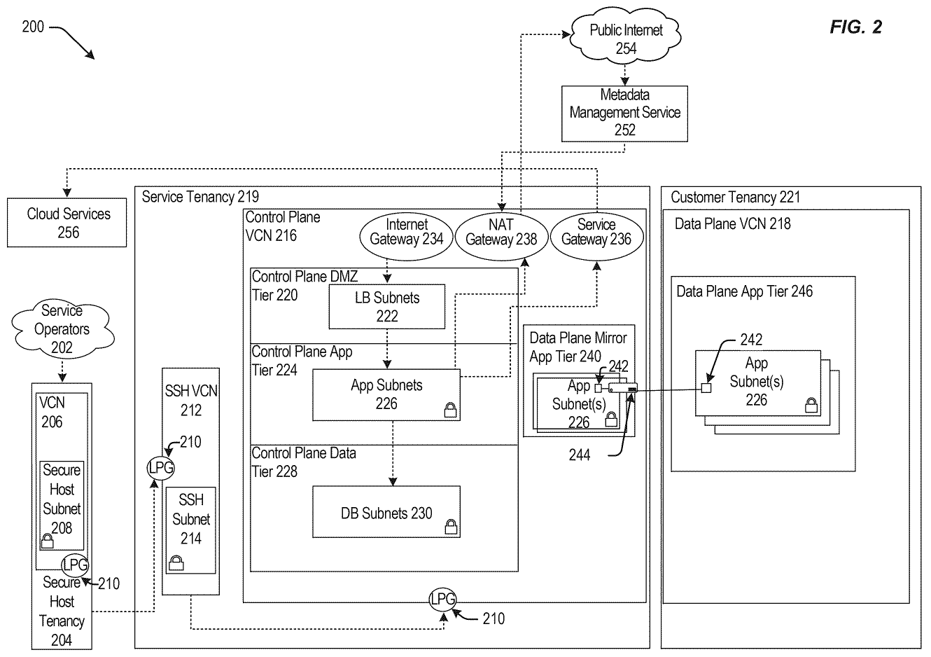

FIG. 2 is a block diagram illustrating another example pattern of an IaaS architecture 200 according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), and a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216. The app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively couple to cloud services 256 (e.g., cloud services 156 of FIG. 1).

In some examples, the data plane VCN 218 can be contained in the customer tenancy 221. In this case, the IaaS provider may provide the control plane VCN 216 for each customer, and the IaaS provider may, for each customer, set up a unique, compute instance 244 that is contained in the service tenancy 219. Each compute instance 244 may allow communication between the control plane VCN 216 contained in the service tenancy 219 and the data plane VCN 218 that is contained in the customer tenancy 221. The compute instance 244 may allow resources provisioned in the control plane VCN 216 that is contained in the service tenancy 219 to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment or other usage of resources of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

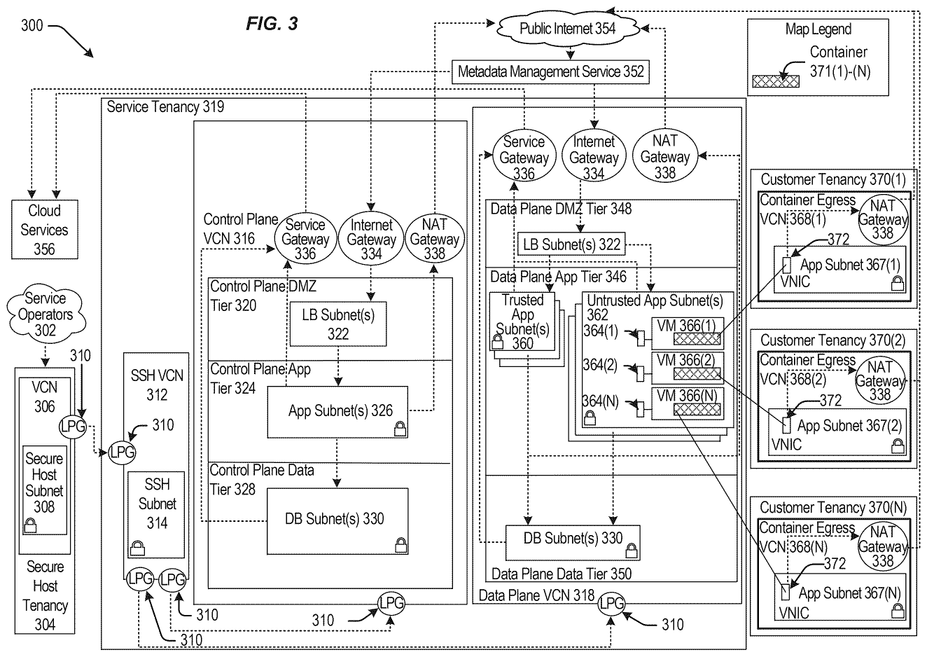

FIG. 3 is a block diagram illustrating another example pattern of an IaaS architecture 300 according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane VCN 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), and a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360, untrusted app subnet(s) 362 of the data plane app tier 346, and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Each tenant VM 366(1)-(N) can be communicatively coupled to a respective app subnet 367(1)-(N) that can be contained in respective container egress VCNs 368(1)-(N) that can be contained in respective customer tenancies 380(1)-(N). Respective secondary VNICs 372(1)-(N) can facilitate communication between the untrusted app subnet(s) 362 contained in the data plane VCN 318 and the app subnet contained in the container egress VCNs 368(1)-(N). Each container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management service 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 380. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether or not to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. Each VM 366(1)-(N) may be connected to one customer tenancy 380. Respective containers 381(1)-(N) contained in the VMs 366(1)-(N) may be configured to run the code. In this case there can be a dual isolation (e.g., the containers 381(1)-(N) running code), where the containers 381(1)-(N) may be contained in at least the VM 366(1)-(N) that are contained in the untrusted app subnet(s) 362) that may help prevent incorrect or otherwise undesirable code from damaging the network of the IaaS provider or from damaging a network of a different customer. The containers 381(1)-(N) may be communicatively coupled to the customer tenancy 380 and may be configured to transmit or receive data from the customer tenancy 380. The containers 381(1)-(N) may not be configured to transmit or receive data from any other entity in the data plane VCN 318. Upon completion of running the code, the IaaS provider may kill or otherwise dispose of the containers 381(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 381(1)-(N) that can be contained in the VM 366(1)-(N) of each customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

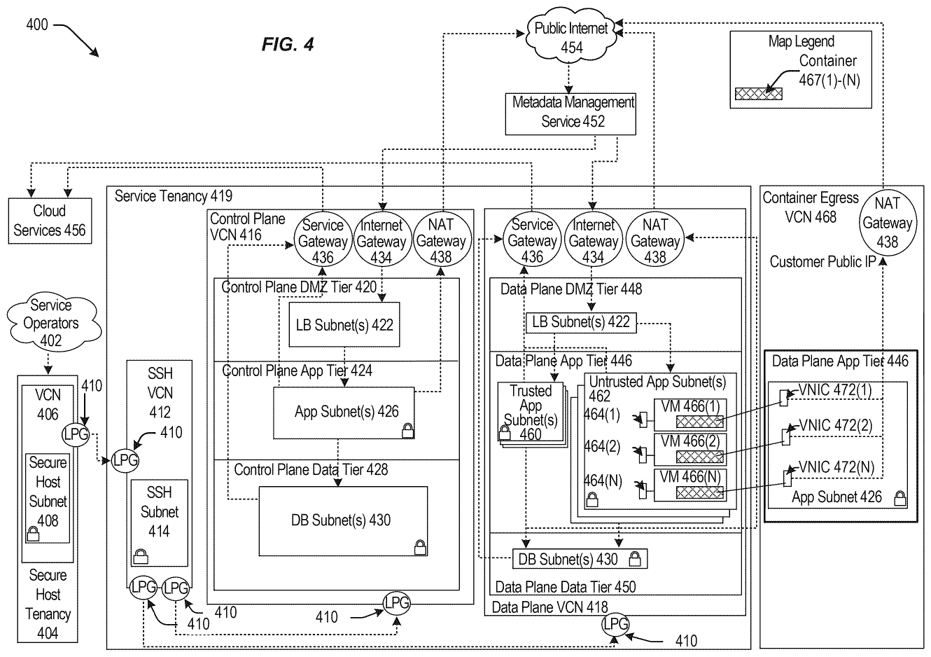

FIG. 4 is a block diagram illustrating another example pattern of an IaaS architecture 400 according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane VCN 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), and a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Each tenant VM 466(1)-(N) can run code in a respective container 467(1)-(N) and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management service 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively couple to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467(1)-(N) that are contained in the VMs 466(1)-(N) for each customer can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467 (1)-(N) that can be accessed in real time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that request a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, and 400 may include components that are different and/or additional to the components shown in the figures. Further, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited, to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource when the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, each database implemented by a multi-tenant computer network may be tagged with a tenant ID. A tenant associated with the corresponding tenant ID may access data of a particular database. As another example, each entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for each tenant, a set of applications that the tenant is authorized to access. For each application, a list of tenant IDs of tenants authorized to access the application is stored. A tenant is permitted access to a particular application when the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 3. Computer System

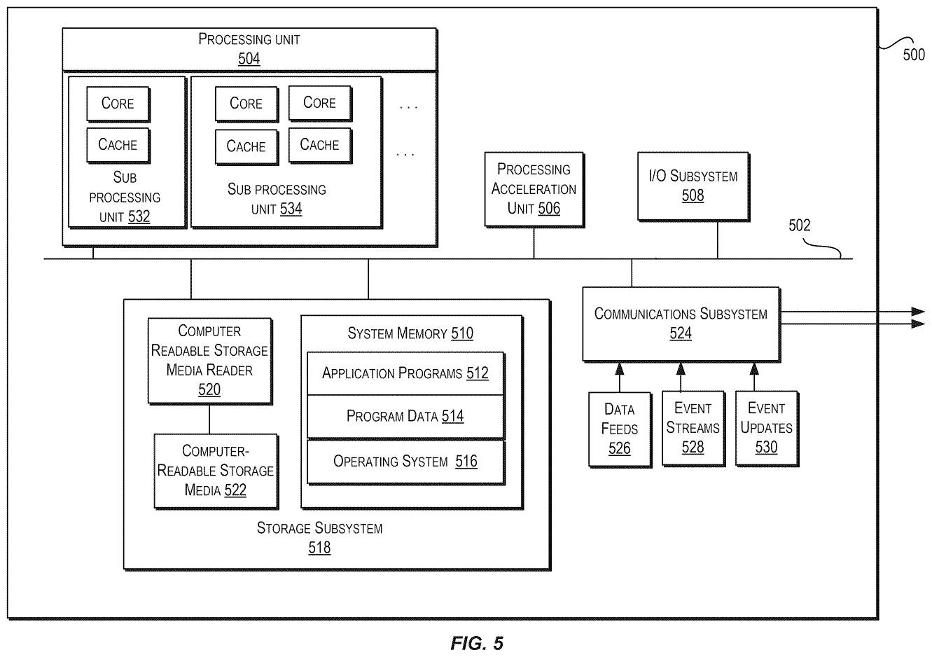

FIG. 5 illustrates an example computer system 500. An embodiment of the disclosure

may be implemented upon the computer system 500. As shown in FIG. 5, computer system 500 includes a processing unit 504 that communicates with peripheral subsystems via a bus subsystem 502. These peripheral subsystems may include a processing acceleration unit 506, an I/O subsystem 508, a storage subsystem 518, and a communications subsystem 524. Storage subsystem 518 includes tangible computer-readable storage media 522 and a system memory 510.

Bus subsystem 502 provides a mechanism for letting the various components and subsystems of computer system 500 to communicate with each other as intended. Although bus subsystem 502 is shown schematically as a single bus, alternative embodiments of the bus subsystem may utilize multiple buses. Bus subsystem 502 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the IEEE P1386.1 standard.

Processing unit 504 controls the operation of computer system 500. Processing unit 504 can be implemented as one or more integrated circuits (e.g., a conventional microprocessor or microcontroller). One or more processors may be included in processing unit 504. These processors may include single core or multicore processors. In certain embodiments, processing unit 504 may be implemented as one or more independent processing units 532 and/or 534 with single or multicore processors included in each processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, the program code to be executed can be wholly or partially resident in processing unit 504 and/or in storage subsystem 518. Through suitable programming, processing unit 504 can provide various functionalities described above. Computer system 500 may additionally include a processing acceleration unit 506 that can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices such as computed tomography, magnetic resonance imaging, position emission tomography, or medical ultrasonography devices. User interface input devices may also include audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 500 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 500 may comprise a storage subsystem 518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 504 provide the functionality described above. Storage subsystem 518 may also provide a repository for storing data used in accordance with the present disclosure.

As depicted in the example in FIG. 5, storage subsystem 518 can include various components, including a system memory 510, computer-readable storage media 522, and a computer readable storage media reader 520. System memory 510 may store program instructions, such as application programs 512, that are loadable and executable by processing unit 504. System memory 510 may also store data, such as program data 514, that is used during the execution of the instructions and/or data that is generated during the execution of the program instructions. Various programs may be loaded into system memory 510 including, but not limited to, client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 510 may include a basic input/output system (BIOS) containing basic routines that help to transfer information between elements within computer system 500 such as during start-up.

Computer-readable storage media 522 may represent remote, local, fixed, and/or removable storage devices plus storage media for temporarily and/or more permanently containing, storing, computer-readable information for use by computer system 500, including instructions executable by processing unit 504 of computer system 500.

Computer-readable storage media 522 can include any appropriate media known or used in the art, including storage media and communication media, such as but not limited to volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include solid-state drives (SSD) based on non-volatile memory, such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments, communications subsystem 524 can include radio frequency (RF) transceiver components to access wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services, such as Twitter® feeds, Facebook® updates, web feeds such as Rich Site Summary (RSS) feeds, and/or real-time updates from one or more third party information sources.

Additionally, communications subsystem 524 may be configured to receive data in the form of continuous data streams. The continuous data streams may include event streams 528 of real-time events and/or event updates 530 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in FIG. 5 is intended as a non-limiting example. Many other configurations having more or fewer components than the system depicted in FIG. 5 are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 4. Layout Generator Architecture

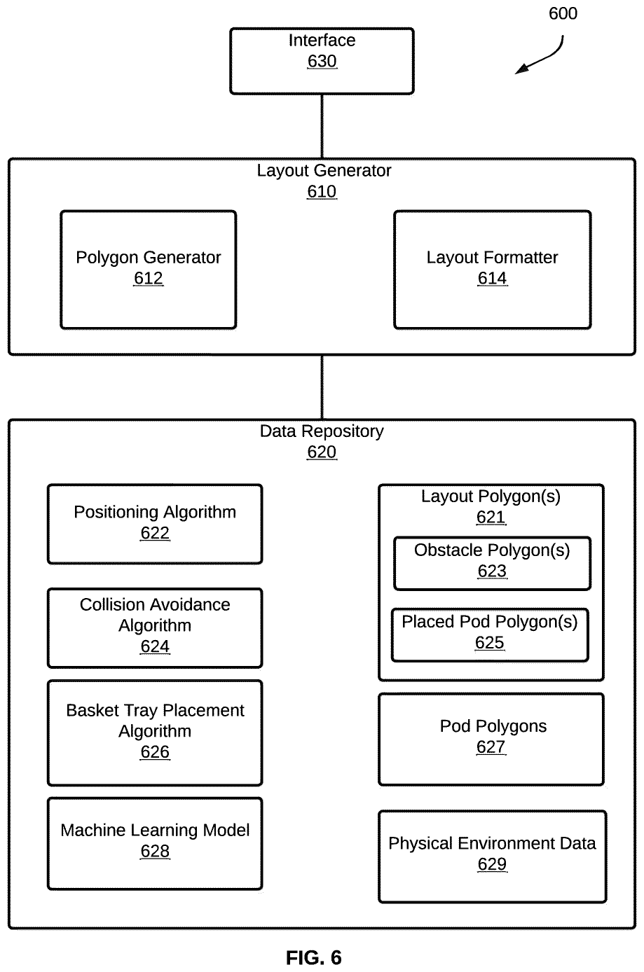

FIG. 6 illustrates a system 600 in accordance with one or more embodiments. As illustrated in FIG. 6, system 600 includes a layout generator 610, a data repository 620, and an interface 630. In one or more embodiments, the system 600 may include more or fewer components than the components illustrated in FIG. 6. The components illustrated in FIG. 6 may be local to or remote from each other. The components illustrated in FIG. 6 may be implemented in software and/or hardware. Each component may be distributed over multiple applications and/or machines. Multiple components may be combined into one application and/or machine. Operations described with respect to one component may instead be performed by another component.

In one or more embodiments, layout generator 610 refers to hardware and/or software configured to perform operations described herein for generating a layout for a data center. Examples of operations for generating a layout for a data center are described below with reference to FIG. s 7-9. The layout generator 610 may include one or more functional components, such as a polygon generator 612 and a layout formatter 614.

In one or more embodiments, polygon generator 612 refers to hardware and/or software configured to perform operations described herein for generating polygons used in generating a layout for a data center. The polygon generator 612 may ingest physical environment data 629 and create one or more layout polygons 621. Physical environment data 629 may include information describing a physical environment that will house a data center. The information may include, for example, physical dimensions of rooms within a building that will house equipment for the data center. The polygon generator 612 may generate a layout polygon that corresponds to a room in the data center, where the dimensions of the layout polygon are a scaled representation of the internal dimensions of the room. When a data center includes multiple rooms and/or multiple buildings, the polygon generator 612 generates a corresponding number of layout polygons for the one or more multiple rooms and/or the multiple buildings.

Physical environment data 629 may include information describing internal structures within the building that will house equipment for the data center. The information may include, for example, the dimensions and locations of fixed structures such as staircases, doors, windows, pillars, beams, light fixtures, and heating, ventilation, and cooling (HVAC) fixtures. The polygon generator 612 may generate one or more obstacle polygons 623 based on the information describing internal structures. The polygon generator 612 may scale the dimensions of an internal structure to the scale of the layout polygon and represent the internal structure with the smallest polygon that contains the scaled dimensions. The polygon generator 612 may associate an obstacle polygon with a set of coordinates in the layout polygon corresponding to the position of internal structure in the physical environment.

The polygon generator 612 may generate one or more pod polygons 627. A pod polygon corresponds to a physical pod that can be placed in the data center. A pod is a modular unit that corresponds to a grouping of rows of racks. A pod also includes elements for power distribution, and heat exchange. Pods may come in different sizes, such as a pod with 10 rows each having 24 rack positions, a pod with 10 rows each having 12 rack positions, or a pod with 6 rows each having 24 rack positions. The dimensions of a pod polygon are proportional to the dimensions of a physical pod that can be placed in the data center. The pod polygons 627 include one pod polygon per size of pod that can be placed in a data center. If a new pod size is introduced, the polygon generator 612 may receive information describing the size of the pod. The polygon generator creates a pod polygon corresponding to the new pod and stores the new pod polygon in the set of pod polygons. A pod polygon may include a set of rack polygons that correspond to the racks within the pod.

The layout generator 610 may execute operations to generate a layout of pods for physical environment represented by a layout polygon 621. Based on a given layout polygon and the set of obstacle polygons associated with the given layout polygon, the layout generator 610 selects pods from the pod polygons 627 and determines a layout that optimizes a set of placed pod polygons 625 with respect to one or more constraints. The layout generator 610 may generate a plurality of candidate layouts and select the layout that satisfies the most constraints. Constraints may include, for example, maximizing an amount of occupied floor space, minimizing an amount of unused floor space, or using the largest number of the largest pods.

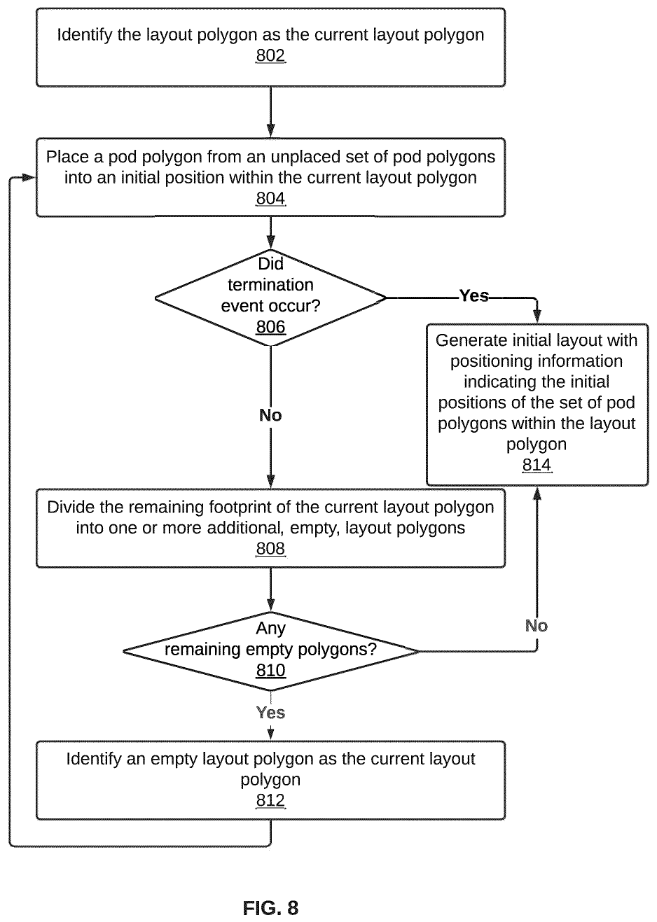

The layout generator 610 may use one or more algorithms to generate a layout, for example, a positioning algorithm 622, a collision avoidance algorithm 624, and a basket tray placement algorithm 626. The positioning algorithm 622 may generate an initial layout of pod polygons within a layout polygon without considering the obstacle polygons. An example of the operations of the positioning algorithm is discussed below with reference to FIG. 8.

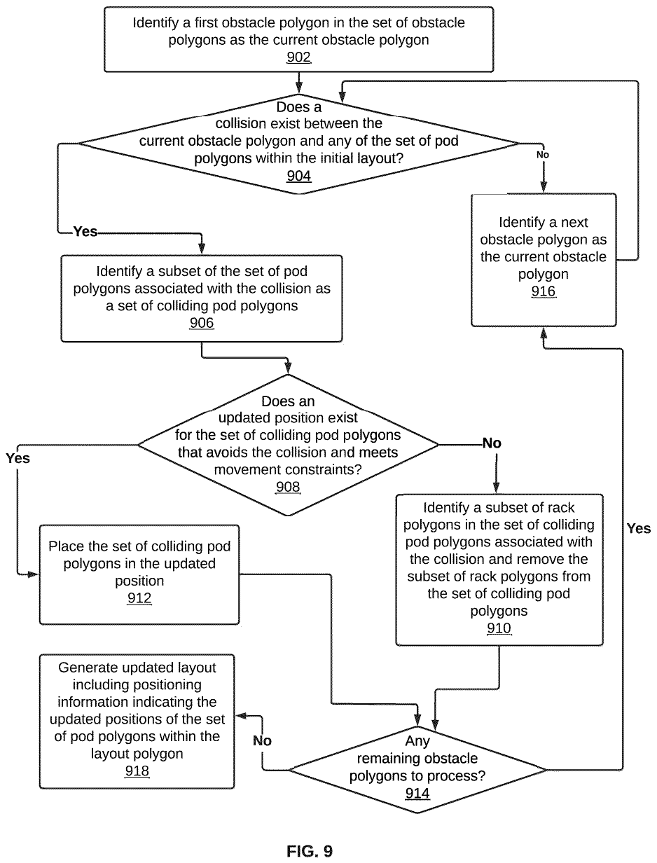

The collision avoidance algorithm 624 may identify collisions in a layout polygon between the pod polygons and the obstacle polygons and attempt to remove the collision by moving pod polygons or removing one or more rack polygons from a pod polygon. An example of the operations of the collision avoidance algorithm is discussed below with reference to FIG. 9.

The basket tray placement algorithm 626 may generate a path for a row of basket trays that will be installed above the pods. Server and network racks in a data center are interconnected by cables within a pod and across pods. These cables run on basket trays that are installed above the racks, facing the roof of the data hall. Basket trays are installed end-to-end, extending between opposing walls of a room across a row of racks where the cables connect to cables at the perimeter of the room. Basket trays may be preferably installed over the center portions of a pod, or nearest to network racks. If an obstacle is present in the preferred path, the basket tray placement algorithm determines modifications to the preferred path to avoid the obstacle while minimizing the number of basket trays needed.

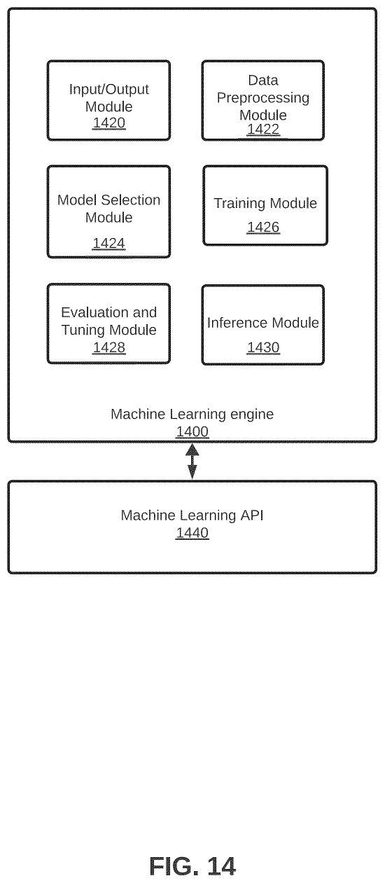

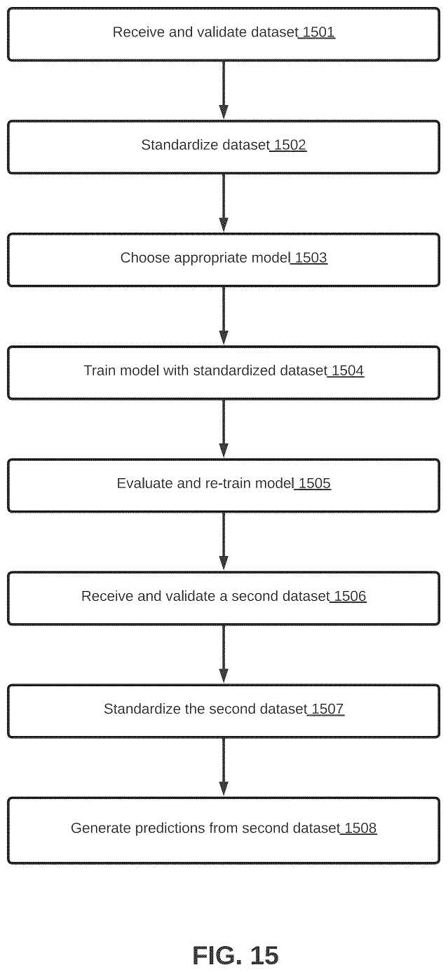

In one or more embodiments, the layout generator 610 may use a machine learning model 628 to generate a layout. The layout generator 610 may apply a machine learning model to physical environment data, including obstacles, pod polygons, and a set of constraints to select a starting position for a pod polygon within a layout polygon, for use by the positioning algorithm. The layout generator 610 may apply a machine learning model to physical environment data, including obstacles, pod polygons, and a set of constraints to generate an optimized layout, without the use of the positioning algorithm and/or the collision avoidance algorithm. The machine learning model may be trained on training data including previously generated layouts. Machine learning models and machine learning algorithms are described below in reference to FIGS. 14 and 15.

In one or more embodiments, layout formatter 614 refers to hardware and/or software configured to perform operations described herein for generating design files from the layouts. For example, if the layout information is created in a JSON format, the layout formatter 614 may convert the JSON data to a computer assisted design (CAD) format. The layout formatter 614 may add information to the CAD file(s) such as rack numbering, basket tray labels, and labels on racks that are omitted to minimize collisions.

In one or more embodiments, a data repository 620 is any type of storage unit and/or device (e.g., a file system, database, collection of tables, or any other storage mechanism) for storing data. Further, a data repository 620 may include multiple different storage units and/or devices. The multiple different storage units and/or devices may or may not be of the same type or located at the same physical site. Further, a data repository 620 may be implemented or executed on the same computing system as layout generator 610. Additionally, or alternatively, a data repository 620 may be implemented or executed on a computing system separate from layout generator 610. The data repository 620 may be communicatively coupled to layout generator 610 via a direct connection or via a network.

Information describing the algorithms and layouts described herein may be implemented across any of components within the system 600. However, this information is illustrated within the data repository 620 for purposes of clarity and explanation.

In an embodiment, layout generator 610 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, interface 630 refers to hardware and/or software configured to facilitate communications between a user and layout generator 610. Interface 630 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 630 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 630 is specified in one or more other languages, such as Java, C, or C++.

### 5. Generating a Layout for a Data Center

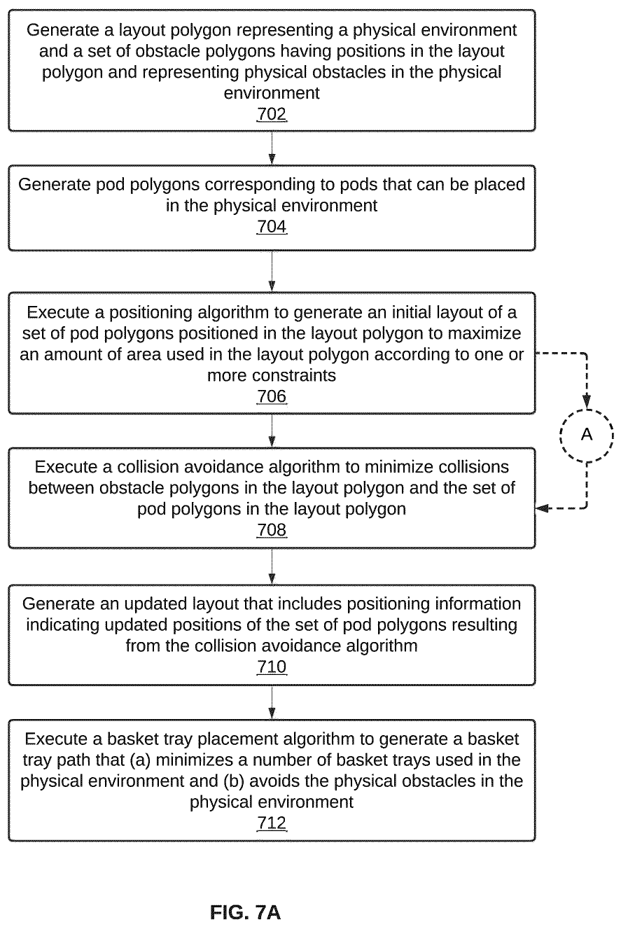

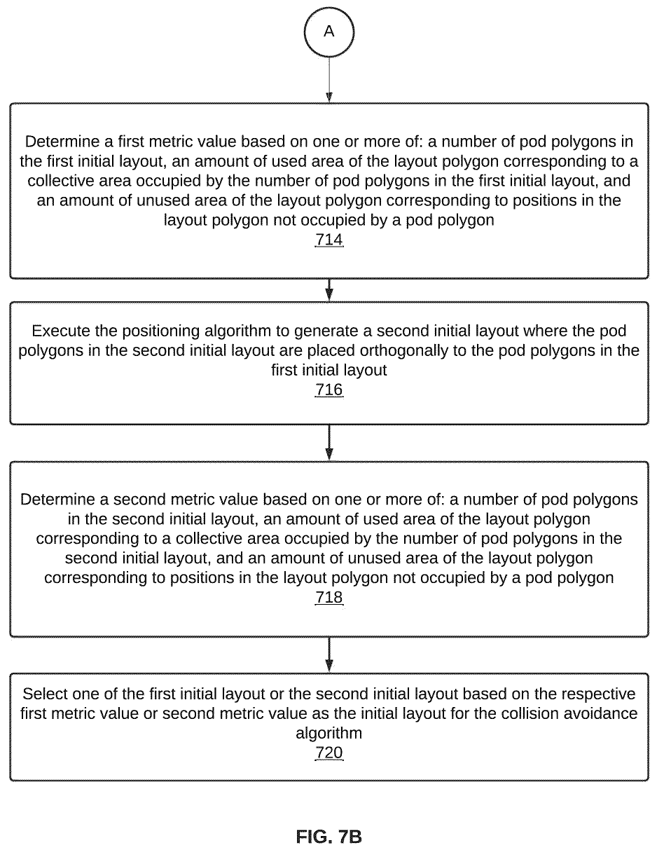

FIGS. 7A and 7B illustrate an example set of operations for generating a layout for a data center in accordance with one or more embodiments. One or more operations illustrated in FIGS. 7A-B may be modified, rearranged, or omitted all together. Accordingly, the particular sequence of operations illustrated in FIGS. 7A-B should not be construed as limiting the scope of one or more embodiments.

In an embodiment, the system generates a layout polygon representing a physical environment and a set of obstacle polygons representing physical obstacles in the physical environment (Operation 702). The system may extract room and obstacle geometries from physical environment data, for example, from CAD files that represent floor plans for the physical environment. The system may generate a data structure that represents the physical environment, including the dimensions. The system generates a layout polygon corresponding to the dimensions of the physical environment. The system may include a buffer space in a layout polygon that defines a distance from an inner side of a room wall where a pod may not be placed.

The system may generate data structures to represent individual obstacles in the physical environment such as doors, stairs, beams, columns, HVAC fixtures, and walkways. The data structures, e.g., JSON data structures, may include information describing an obstacle's location, dimensions and type. The system generates a set of obstacle polygons corresponding to the dimensions and locations of the obstacles. The system may generate coordinates for an obstacle polygon within the layout polygon based on the location information.

In an embodiment, the system generates pod polygons corresponding to pods that can be placed in the environment (Operation 704). The system may access one or more configuration files that define one or more types of pods that can be used in the physical environment. Based on a pod definition, the system can calculate the area of the footprint of a pod, i.e., the length and width of the pod where the pod contacts the floor. The system generates a polygon corresponding to the dimension of the perimeter of the footprint. Alternatively, the system can access existing pod polygons corresponding to pods in the configuration files.

In an embodiment, the system executes a positioning algorithm to generate an initial layout of set of pod polygons positioned in the layout polygon (Operation 706). The system may place pod polygons one at a time in a layout polygon until there is no more room in the layout polygon to add another pod polygon. The system may begin in a corner of the layout polygon outside of a buffer space defined for the walls. The system may add the next pod polygon next to the previous pod polygon to create a row (or column) of pod polygons in the layout polygon. The system may select a location to begin a new row (or column) of pod polygons separated from the previous row (or column) by, at least, a defined minimum separation distance. When a pod of one size is too large to be placed in position in the layout polygon, the system may attempt to place a smaller pod polygon in the position instead. Once placed, the system may write position information to data structures representing the respective place pod polygons. An example of a positioning algorithm is described further below with reference to FIG. 8.

In an embodiment, the system executes a collision avoidance algorithm to minimize collisions between obstacle polygons and the pod polygons in the layout polygon (Operation 708). The system may determine if an obstacle polygon overlaps with one or more of the pod polygons placed in the layout polygon, based on the coordinates of the obstacle polygon and the coordinates of the pod polygons. When the obstacle polygon overlaps with a pod polygon, a collision exists. The system may then attempt to shift the entire row (or column) of pod polygons that include the colliding pod polygon(s) away from the obstacle polygon to remove the collision. The system may attempt to move the row (or column) of polygons horizontally, vertically, or both within the layout polygon. The system may not move the row (or column) of polygons if the movement violates a movement constraint. For example, the movement may not place the moved polygons within the buffer space of the layout polygon. The movement may not place the moved polygons within the defined minimum separation distance of an adjacent row (or column) of pod polygons. If there is no permitted movement that removes the collision, the system may remove one or more rack polygons from the colliding pod polygon(s) to remove the collision. An example of a collision avoidance algorithm is described further below with reference to FIG. 9.

In an embodiment, the system generates an updated layout that includes positioning information indicating updated positions of the pod polygons in the layout polygon resulting from the collision avoidance algorithm (Operation 710). The system may update position information in the pod data structures corresponding to the placed pod polygons. The system may use the positioning information from the data structures to generate one or more CAD files showing the placed pods in the floor plan for the physical environment.

In an embodiment, the system executes a basket tray placement algorithm to generate a basket tray path (Operation 712). The system may generate a basket tray path that (a) minimizes a number of basket trays used in the physical environment and (b) avoids the physical obstacles in the physical environment. The system may use aspects of an A-star path finding algorithm to find a path for the basket trays that minimizes a path length while conforming to constraints, including that turns must be 90 degrees and that neither curved paths nor diagonal paths are permitted due to the rectangular shape of basket trays.

The system may initially apply a two-dimensional (2D) grid to the layout polygon. The size of a grid unit may correspond to a width of a rack. For a particular row (or column) of pods, the system determines the grid coordinates for a pod on the end of the row (or column).

The system may begin a linear path from the nearest side of the layout polygon toward the end pod, in an initial orientation, such that the linear path is perpendicular to the nearest side and may intersect a central portion of the end pod, or with the portion of the end pod that includes network racks. The system extends the linear path by segments, one grid unit at a time. When a new path segment is added, the system determines if the path segment collides with an obstacle polygon. When there is no collision, the system adds another path segment and checks for collision.

When a path segment collides with an obstacle polygon, the system rotates the path segment by 90 degrees away from the obstacle polygon and adds the rotated path segment to the end of the previous path segment. The system may then determine if a next segment can be added to the end of the rotated segment at a 90-degree rotation from the rotated segment such that the next segment will align with the initial orientation without colliding. For example, following a left turn, the system may determine if the path can turn right.

If the next segment cannot be added in the initial orientation without collision, the system extends the linear path with the next segment at the current orientation. The system repeats adding segments and testing for collision until a segment can be added in the initial orientation. Then the system may extend the path line until the end of a segment passes the obstacle polygon. Then the system may turn the path line 90 degrees back toward the initial position that the linear path would be on, absent the obstacle. The system may continue the placement of segments until the linear path reaches the opposite side of the layout. The linear path connects to the room perimeter at points that are as close as possible to the end pods.

In an embodiment, the system may output the basket tray paths with positional information for the linear segments of the basket tray paths. The system may include the basket tray paths in one or more CAD files representing structures in the physical environment.

Turning to FIG. 7B, in an embodiment, after Operation 706, the system may optionally determine a first metric value based on the initial layout (Operation 714). The system may determine a number of racks based on the number of pod polygons in the first initial layout. The system may determine an amount of used area of the layout polygon corresponding to a collective area occupied by the number of pod polygons in the first initial layout. The system may determine an amount of unused area of the layout polygon corresponding to positions in the layout polygon not occupied by a pod polygon or an obstacle polygon. The system may calculate a percentage of the available space used in the layout polygon.

The system may determine the first metric value as a vector containing separate values for one or more of the number of racks, the amount of used space, the amount of unused space, and the percentage of used space. Additionally, or alternatively, the system may calculate a metric value using one or more of the number of racks, the amount of used space, the amount of unused space, and the percentage of used space as inputs. The system may weight the values according to a constraint or a priority. For example, if a maximum number of racks is desired, the rack number may be weighted more than a value of the amount of used space.

In an embodiment, the system executes the positioning algorithm to generate a second initial layout (Operation 714). The system may execute the positioning algorithm such that the pod polygons in the second initial layout are placed orthogonally to the placement of the pod polygons in the first initial layout. For example, if the pod polygons are placed in columns in the first initial layout, e.g., arranged from the bottom to the top of the layout polygon, the system places the pod polygons in rows in the second initial layout, e.g., arranged from left to right of the layout polygon.

In an embodiment, the system determines a second metric value based on the second initial layout (Operation 718). The system uses the same calculations and input variables for the second metric value as for the first metric value.

In an embodiment, the system selects one of the first and second initial layouts based on the respective values of the first and second metric values (Operation 720). The system may select, for example, the layout that has the largest number of placed racks. The system may select, for example, the layout that correspond to the largest amount of used space. The selected layout becomes the input layout for the collision avoidance operation in Operation 708.

FIG. 8 illustrates an example set of operations for a positioning algorithm in accordance with one or more embodiments. The positioning algorithm may be a modified bin packing algorithm. One or more operations illustrated in FIG. 8 may be modified, rearranged, or omitted all together. Accordingly, the particular sequence of operations illustrated in FIG. 8 should not be construed as limiting the scope of one or more embodiments.

In an embodiment, the system identifies the layout polygon as the current layout polygon (Operation 802). Initially, there is one layout polygon corresponding to a room where the pods will be placed. The system may generate a queue to hold one or more layout polygons for processing. The layout polygon(s) in the queue are considered empty. The system may dequeue the layout polygon as the current layout polygon.

In an embodiment, the system places a pod polygon into an initial position of the current layout polygon (Operation 804). The system may select a pod polygon having the largest area of the available pod polygons. For the first pod polygon in the layout polygon, the system may select a corner of the layout polygon, outside of a buffer area as the initial position. For subsequent pod polygons, the system may select an initial position in the current layout polygon based the position of the previously placed pod polygon. For example, in a column-wise arrangement where the first pod polygon was placed in a lower left corner of the layout polygon, the system will attempt to place the next pod polygon above the first pod polygon. The system may select the initial position for a pod polygon such that a buffer space between pods is maintained.

In an embodiment, if there is no pod polygon that can fit into the current layout polygon, the current layout polygon may be discarded and the next empty layout polygon in the queue, if any, may be selected as the current pod polygon.

In an embodiment, the system determines if a termination event has occurred (Operation 806). The system may determine that a termination event has occurred when there are no pod polygons that can fit in the remaining empty layout polygons. The system may compare the dimensions of the pod polygons to the dimensions of the remaining empty layout polygons in the queue.

The system may determine that a termination event has occurred when a power constraint or other resource constraint has been reached by placed pods. The system may calculate a total expected power consumption value for the pods that have been placed. The system may compare the total expected power consumption to a value of the room's available power capacity. When the total expected power consumption meets or exceeds the room's available power capacity, no more pods may be placed in the room and a termination event has occurred.

In an embodiment, when a termination event has not occurred, the system divides the remaining footprint of the current layout into one or more additional, empty, layout polygons (Operation 808). For example, the system may create one new empty layout polygon having a height equal to the difference between the height of the current layout polygon and the height of the placed pod polygon, and with the width of the placed pod polygon. The system may create a second new empty layout polygon having a width equal to the difference between the width of the current layout polygon and the width of the placed pod polygon and the height of the placed pod polygon. The system may create a third new empty layout polygon from the remaining area of the current pod polygon.

By way of example, for a current pod polygon of height H and width W, when a pod polygon of height h and width w is placed in a corner of the current layout polygon, the first new layout polygon will have a height H-h, and a width w. The second new pod polygon will have a height h, and a width W-w. The third new polygon will have a height H-h and a width W-w. If either of the dimensions of a new layout polygon is zero, no new layout polygon is created or queued.

In an embodiment, the system determines if there are any remaining empty layout polygons (Operation 810). The system may check if the queue is empty.

In an embodiment, the system identifies an empty layout polygon as the current layout polygon (Operation 812). The system may dequeue the next empty layout polygon.

When there are no remaining empty layout polygons or when a termination event has occurred, the system generates the initial layout of pod polygons within the initial layout polygon (Operation 814). The initial layout indicates the initial positions and types of pod polygons placed in the initial layout polygon.

FIG. 9 illustrates an example set of operations for a collision avoidance algorithm in accordance with one or more embodiments. One or more operations illustrated in FIG. 9 may be modified, rearranged, or omitted all together. Accordingly, the particular sequence of operations illustrated in FIG. 9 should not be construed as limiting the scope of one or more embodiments.

In an embodiment, the system identifies a first obstacle polygon in the set of obstacle polygons as the current obstacle polygon (Operation 902). The system may select a first obstacle polygon based on the positions of the obstacle polygons in the layout polygon. For example, the system may select the first obstacle polygon that is closest to a side or a corner of the layout polygon. The system may select the first obstacle polygon that is closest to a central portion of the layout polygon. The system may enqueue the obstacle polygons in the set of obstacle polygons in a processing order based on the positions of the obstacle polygons in the layout polygon. The system may maintain respective indicators for the obstacle polygons in the set of obstacle polygons, where the indicator indicates if an obstacle polygon has been processed for collisions. When the system identifies an obstacle polygon for processing, the system updates the indicator.

In an embodiment, the system determines if a collision exists between the current obstacle polygon and any of the set of pod polygons in the initial layout (Operation 904). The system may access position information for a pod polygon in the layout polygon and determine if the position of the pod polygon overlaps with the position of the current obstacle polygon. The system may select one or more pod polygons to check for a collision based on the position and dimensions of the current obstacle polygon, rather than checking all of the pod polygons for collision with the current obstacle polygon.

In an embodiment, the system calculates a collision area based on the area of the part of the current obstacle polygon that overlaps with an area of part of one or more pod polygons. The system may calculate or count the number of pod polygons that collide with the current obstacle polygon.

In an embodiment, the system identifies a subset of the set of pod polygons associated with the collision as a set of colliding pod polygons (Operation 906). The racks in a given row generally must be aligned with each other and cannot be staggered with respect to each other. Therefore, the system may identify the entire row (or column) of pod polygons containing the one or more pod polygons involved in the collision as the subset of colliding pod polygons.

In an embodiment, the system determines if an updated position exists for the set of colliding pod polygons that avoids the collision (Operation 908). The system also determines if the updated position meets one or more movement constraints. The system may select an initial movement direction, e.g., horizontal or vertical. The system may select the initial movement direction according to the orientation of the set of colliding pod polygons. For example, in a columnar orientation, the system may select a horizontal movement direction. The system may determine a left or right movement direction. The system may select to a left or right direction according to one or more factors. For example, the system may identify the side of the colliding pod polygon(s) that is involved in the collision and may select to move the set of colliding pod polygons away from that side. If the right side of a pod polygon collides with the current obstacle polygon, the system may move the set of colliding pod polygons toward the left.

The system may move the set of colliding pod polygons in the movement direction by a movement distance. The system may move the set of colliding pod polygons in increments of a set distance without regard to amount of the overlap area, for example, by an amount corresponding to one foot. Alternatively, the system may calculate the length of the overlap area in the dimension corresponding to the movement direction and may attempt to move the set of colliding pod polygons by the length of the overlap area. In the above example, if the current obstacle polygon overlaps a pod polygon horizontally by a length corresponding to two feet, the system attempts to move the set of colliding pod polygons bay at least the same length to the left.

The system may determine if the updated position is permitted in view of one or more movement constraints. For example, the updated position may not extend into the buffer space of the layout polygon. The updated position may not extend into the defined minimum separation distance of an adjacent row (or column) of pod polygons. If the updated position violates a movement constraint, the system may attempt movement in a different direction, by a different amount, or both.

The system determines if the updated position removes the collision, for example, by determining if the current obstacle polygon still overlaps the colliding pod polygon(s). If the collision still exists, the system may attempt a different movement, for example, in a different direction, by a different amount, or both. The system may calculate the collision area corresponding to the updated position. Even if a collision still exists, a collision with a smaller area may be preferrable to a collision with a larger area.

In an embodiment, when an updated position does not exist that avoids the collision and meets the movement constraints, the system identifies a subset of rack polygons in the set of colliding pod polygons associated with the collision (Operation 910). The system removes the subset of rack polygons from the set of colliding polygons. The system may select a position for the set of colliding pod polygons, from the initial position and the updated positions, that minimizes the collision area, or that includes the smallest number of pod polygons in the collision. The system may identify the specific pod polygons in the set of colliding pod polygons that collide with the current obstacle polygon. The system may identify one or more specific rack polygons within the specific pod polygons that collide with the current obstacle polygon. The system may remove the identified one or more specific rack polygons from the pod polygon(s) that contain the specific rack polygons. In an embodiment, when a threshold number or percentage of rack polygons in a pod polygon collide with an obstacle polygon, the system may remove the entire pod polygon.

In an embodiment, when an updated position exists that meets the movement constraints, the system places the set of colliding polygons in the updated position (Operation 912). The system may update the data structures corresponding to the pod polygons in the set of colliding polygons with the positioning information for the updated position.

In an embodiment, the system determines if there are any remaining obstacle polygons to process (Operation 914). The system may check a queue of obstacle polygons for any remaining obstacle polygons. The system may check for any obstacle polygons having indicators identifying that the obstacle polygon has not yet been processed.

In an embodiment, when there are remaining obstacle polygons to process, the system identifies a next obstacle polygon in the set of obstacle polygons as the current obstacle polygon (Operation 916). The system may select the next obstacle polygon based on the positions of the obstacle polygons in the layout polygon. For example, the system may select the next obstacle polygon that is closest to the current obstacle polygon in a particular direction, e.g., left to right or bottom to top of the layout polygon. The system may select the next obstacle polygon that is radially outward and closest to the current obstacle polygon. The system may dequeue the next obstacle polygon from a queue.

In an embodiment, when there are no remaining obstacle polygons to process, the system generates an updated layout including positioning information that indicates any updated positions of colliding pod polygons within the layout polygon (Operation 918). The system may update position information in the pod data structures corresponding to the placed pod polygons. The system may use the positioning information from the data structures to generate or update one or more CAD files showing the placed pods in the floor plan for the physical environment.

Avoiding one collision may create another collision. The system may execute the collision avoidance algorithm multiple times, starting with a different obstacle polygon at a next iteration. The system may calculate and store a score corresponding to factors such as the number of collisions in the layout, a total collision area in a layout, and a number of racks removed. The system may select an updated layout based on a minimized value of the calculated score.

### 6. Example Embodiment

One or more detailed examples are described below for purposes of clarity. Components and/or operations described below should be understood as one specific example that may not be applicable to certain embodiments. Accordingly, components and/or operations described below should not be construed as limiting the scope of the claims.

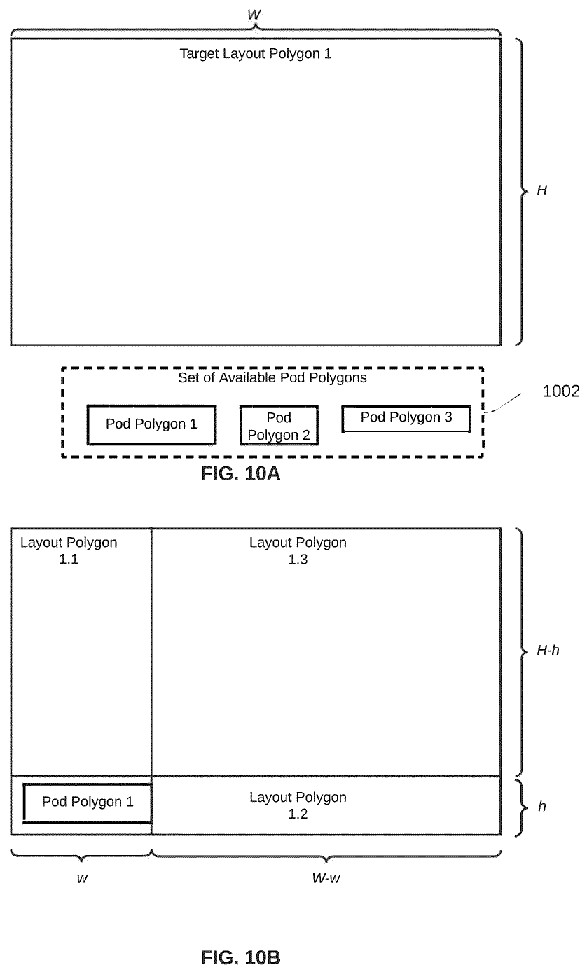

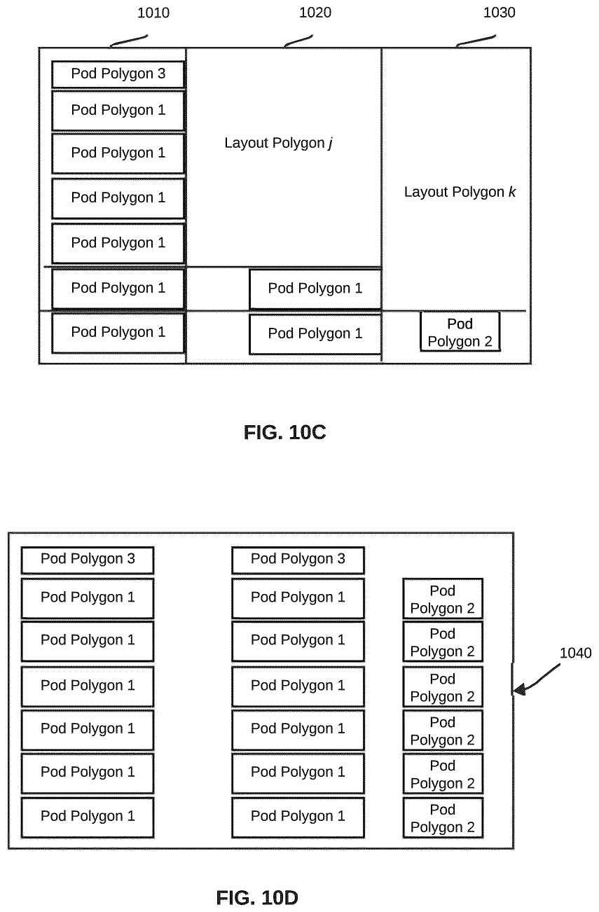

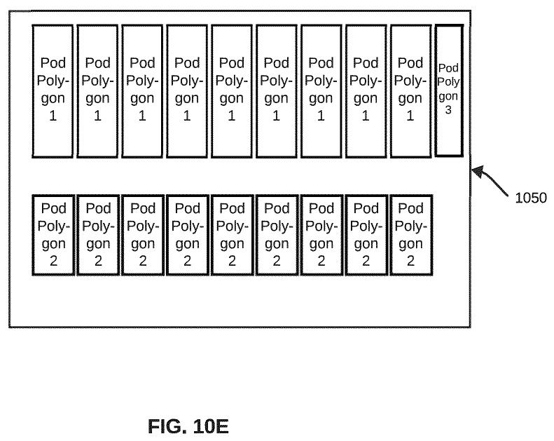

FIGS. 10A-E illustrate an example of a layout in progress in accordance with one or more embodiments. FIG. 10A shows a target layout polygon 1 that represents a room in a data center where pods will be placed. The target layout polygon 1 has a height H and a width W. A set 1002 of available pod polygons includes three types of pod polygons 1, 2, and 3, with respective differences in dimensions and areas.

FIG. 10B shows that a pod polygon 1 is placed in a lower left corner of the target layout polygon, leaving a buffer space between the lower and left walls. After placing the pod polygon, the system divides the target layout polygon into three new empty layout polygons. Layout polygon 1.1 has a height H-h, where h represents the height of pod polygon 1 and buffer space, if any. Layout polygon 1.1 has a width w, where w represents the width of pod polygon 1 and buffer space, if any. Layout polygon 1.2 has a height of h, and a width of W-w. Layout polygon 1.3 has a height of H-h and a width of W-w. The three new empty layout polygons do not overlap one another or the placed pod polygon. The system enqueues the three new empty layout polygons and updates the position information of a data structure corresponding to the place pod polygon to include the position of the placed pod polygon in the target layout polygon.

FIG. 10C shows the layout in progress after several iterations. Of note is that, at the top of the column 1010, the empty layout polygon at the top of the column was too small to accommodate a pod polygon 1, and a smaller pod polygon 3 was placed instead. Similarly, the width of the portion of the target layout polygon indicated as column 1030 was too narrow, including buffer space, to accommodate either pod polygon 1 or pod polygon 3. The system has placed a pod polygon 2. The ordering of pod placement may depend on the order that the system processes the empty layout polygons generated during the placement process. Accordingly, the illustrated placement of pod polygons may differ from other processing orders. Layout polygon j and layout polygon k are empty layout polygons that have not yet been processed.

FIG. 10E shows a completed initial layout 1040 of a set of placed pod polygons within the target layout polygon. The layout 1040 includes twelve pod polygons 1, two pod polygons 3, and six pod polygons 2. The system may calculate the amount of available area of the target layout polygon that is used by the pod polygons in layout 1040.

FIG. 10F shows an alternate layout 1050 generated for the same target layout polygon. The system has repeated the pod placement but in an orientation that is orthogonal to the layout 1040. Where the pod polygons in layout 1040 were laid out in columns, in layout 1050, the system has laid out the pod polygons in rows. The layout 1050 includes nine pod polygons 1, nine pod polygons 2, and one pod polygon 3, fewer pod polygons than the layout 1040. The system may calculate the amount of available area of the target layout polygon that is used by the pod polygons in layout 1050.

Depending on the optimization criteria, the system may select one of the two layouts for use. If the criteria include maximizing the number of placed pods, then the system may select layout 1040. If the criteria include maximizing the amount of area used, the system may select the layout with the larger amount of used layout area.

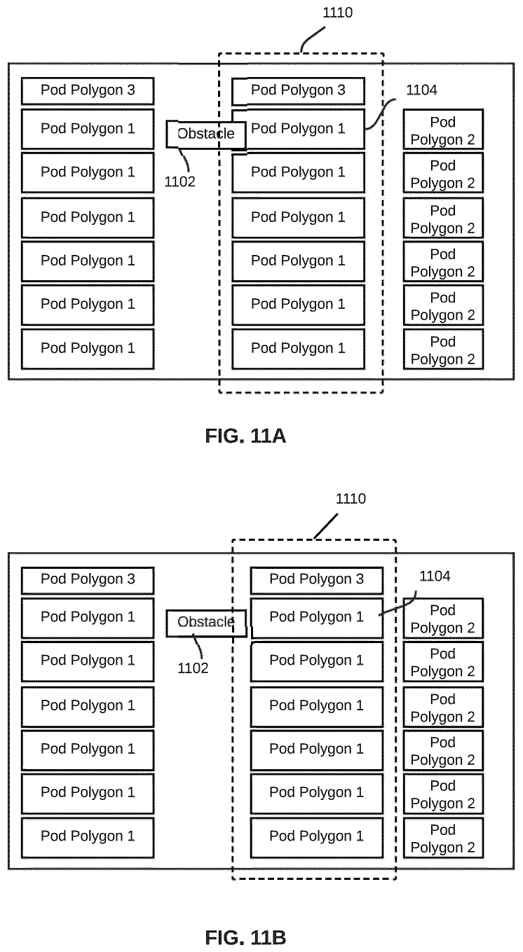

FIGS. 11A-B illustrate an example of a layout in progress with collision avoidance in accordance with one or more embodiments. FIG. 11A shows an obstacle polygon 1102 that overlaps, and therefore collides with, pod polygon 1104. The system identifies the column of pod polygons that includes pod polygon 1104 as the set 1110 of colliding pod polygons.

FIG. 11B shows that the system has shifted the set 1110 of colliding pod polygons away from obstacle polygon 1102 to the right. Provided that the updated position of the set 1110 of colliding pod polygons does not violate movement constraints, the collision is removed. The system may update the positions of the pod polygons in the set 1110 to indicate the new position in the target layout polygon.

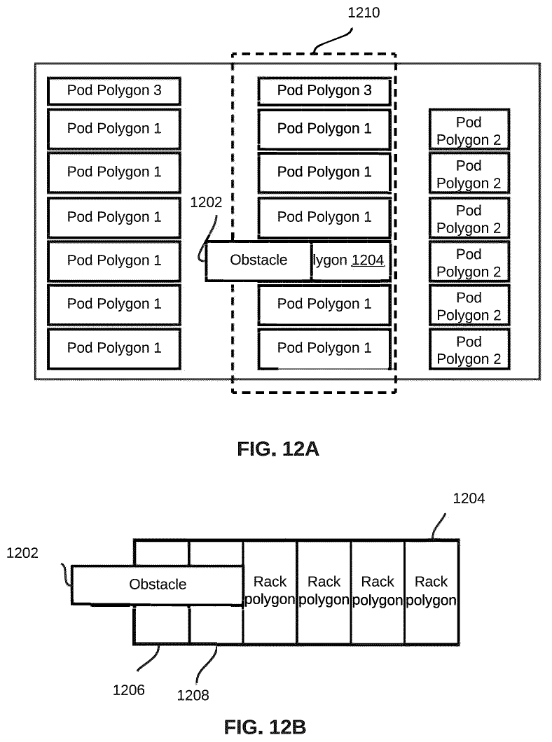

FIGS. 12A-B illustrate another example of a layout in progress with collision avoidance in accordance with one or more embodiments. FIG. 12A shows an obstacle polygon 1202 that overlaps, and therefore collides with, pod polygon 1204. The system identifies the column of pod polygons that includes pod polygon 1204 as the set 1210 of colliding pod polygons. In the illustrated example, the system determines that no updated position exists that removes the collision and meets movement constraints.

FIG. 12B shows a set of rack polygons that are included within the pod polygon 1204. The obstacle 1202 overlaps, and therefore collides with, rack polygons 1206 and 1208. The system may remove rack polygons 1206 and 1208 from pod polygon 1204 to remove the collision.

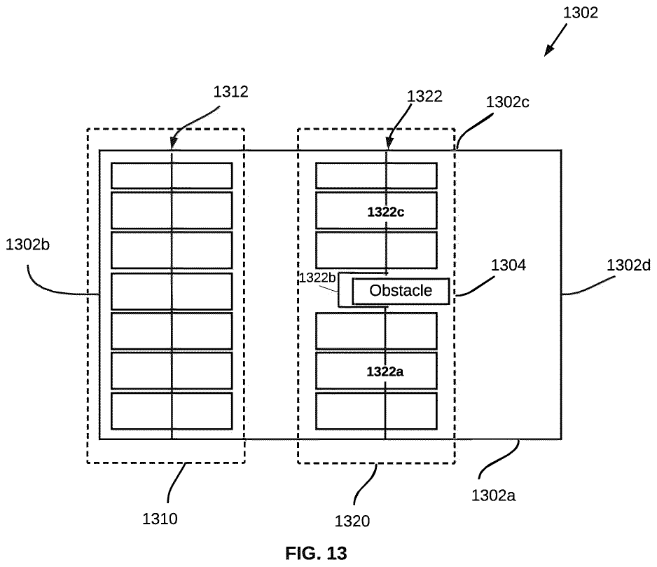

FIG. 13 illustrates examples of basket tray paths in accordance with one or more embodiments. As shown in FIG. 13, a layout polygon 1302 has four sides, corresponding to walls: bottom side 1302a, left side 1302b, top side 1302c, and right side 1302d. The layout polygon 1302 includes two columns of pod polygons 1310 and 1320. One basket tray path 1312 extends from bottom side 1302a linearly through the central portions of the pod polygons in column 1310 to the opposing side 1302c.

The system may first define two parallel lines corresponding to a pair of opposing sides, e.g., for bottom side 1302a and top side 1302c. The system may model the room as a grid and the pod racks as nodes in the grid. The system may define a line perpendicular to the two parallel lines and calculate the intersection points of the perpendicular line with the two parallel lines, where the perpendicular line corresponds to a rack row. Once the system has determined the intersection points, the system may apply an A* (A-star) algorithm to identify a shortest path possible between the intersection points given a set of constraints. The system may constrain the A* algorithm to using Manhattan distance heuristics to enforce right-angle turns and prevent curves and diagonal path segments. The system may constrain path construction along grid lines and constrain turns to occur at grid intersections such that turns occur between adjacent racks. If there are no obstacles, then the basket tray path is equivalent to the perpendicular line.

An obstacle 1304 is present in the area occupied by column 1320. When the system extended the basket tray path 1322 from one of the walls, e.g., from bottom side 1302a, the basket tray path segment 1322a eventually extended across at least part of obstacle 1304. To avoid this collision, the system turned the path 90 degrees away from the initial orientation of the basket tray path. In other words, the next path segment turned from being perpendicular to the bottom side to being parallel with the bottom side. The system continued extending the path parallel to the bottom side until the path could be turned 90 degrees toward the top side while clearing obstacle 1304. Path segment 1322b is parallel with path segment 1322a and extends until the path can be turned 90 degrees back toward the initial path while clearing obstacle 1304. The final segment 1322c extends to and terminates at the top side 1302c where the segment 1322a would have terminated if not for the obstacle.

In cases where basket trays are needed across rack rows, the system may use the basket tray path algorithm to determine the path connecting two basket tray paths across a rack row.

### 7. Practical Applications, Advantages, and Improvements

Conventional approaches to designing the layout of a data hall tend to be time consuming. The resulting layout may be suboptimal, for example, by having fewer racks than could be placed, or having underutilized floor space.

One or more embodiments automate and optimize a layout design process using a modified bin packing algorithm. The modified bin packing algorithm subdivides the layout polygon into smaller layout polygons after placement of a pod polygon and attempts to maximize the amount of space used within a layout polygon. The system then performs a collision avoidance process to minimize the effect of obstacles in the environment on the layout. The system outputs the resulting layout as one or more design artifacts, such as CAD files

### 8. Machine Learning Architecture

FIG. 14 illustrates a machine learning engine 1400 in accordance with one or more embodiments. As illustrated in FIG. 14, machine learning engine 1400 includes input/output module 1420, data preprocessing module 1422, model selection module 1424, training module 1426, evaluation and tuning module 1428, and inference module 1430.

In accordance with an embodiment, input/output module 1420 serves as the primary interface for data entering and exiting the system, managing the flow and integrity of data. This module may accommodate a wide range of data sources and formats to facilitate integration and communication within the machine learning architecture.

In an embodiment, an input handler within input/output module 1420 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. The framework includes mechanisms for batch and real-time data processing that enable the input/output module 1420 to be versatile in different operational contexts, whether processing historical datasets or streaming data.

In accordance with an embodiment, input/output module 1420 manages data integrity and quality as the data enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 1420 includes an output framework designed to handle the distribution and exportation of outputs, predictions, or insights. Using the output framework, input/output module 1420 formats these outputs into user-friendly and accessible formats, such as reports, visualizations, or data files compatible with other systems. Input/output module 1420 also ensures secure and efficient transmission of these outputs to end-users or other systems in an embodiment and may employ encryption and secure data transfer protocols to maintain data confidentiality.

In accordance with an embodiment, data preprocessing module 1422 transforms data into a format suitable for use by other modules in machine learning engine 1400. For example, data preprocessing module 1422 may transform raw data into a normalized or standardized format suitable for training ML models and for processing new data inputs for inference. In an embodiment, data preprocessing module 1422 acts as a bridge between the raw data sources and the analytical capabilities of machine learning engine 1400.

In an embodiment, data preprocessing module 1422 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 1422 may be configured to handle anomalies in different ways depending on context. Data preprocessing module 1422 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 1422 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 1422 processes new data for inference, data preprocessing module 1422 replicates the same preprocessing steps to ensure consistency with the training data format. This helps to avoid discrepancies between the training data format and the inference data format, thereby reducing the likelihood of inaccurate or invalid model predictions.

In an embodiment, model selection module 1424 includes logic for determining the most suitable algorithm or model architecture for a given dataset and problem. This module operates in part by analyzing the characteristics of the input data, such as dimensionality of the input data, distribution, and the type of problem (classification, regression, clustering, etc.).

In an embodiment, model selection module 1424 employs a variety of statistical and analytical techniques to understand data patterns, identify potential correlations, and assess the complexity of the task. Based on this analysis, model selection module 1424 then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 1424 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 1424 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as the lower MSE represents a smaller average discrepancy between the actual and predicted values.

In accordance with an embodiment, model selection module 1424 also considers computational efficiency and resource constraints. This is meant to help ensure the selected model is both accurate and practical in terms of computational and time requirements. In an embodiment, certain features of model selection module 1424 are configurable such as a configured bias toward (or against) computational efficiency.

In accordance with an embodiment, training module 1426 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate the model's performance and adjust parameters accordingly. Training module 1426 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 1426 manages overfitting, where a model learns the training data too well, including the training data's noise and outliers, at the expense of the model's ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 1426 includes logic to handle different types of data and learning tasks. For instance, training module 1426 includes different training routines for supervised learning (where the training data comes with labels) and unsupervised learning (without labeled data). In the case of deep learning models, training module 1426 also manages the complexities of training neural networks that include initializing network weights, choosing activation functions, and setting up neural network layers.

In an embodiment, evaluation and tuning module 1428 incorporates dynamic feedback mechanisms and facilitates continuous model evolution to help ensure the system's relevance and accuracy as the data landscape changes. Evaluation and tuning module 1428 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and the model's capacity to generalize beyond the training data. The module's algorithms meticulously dissect the model's output, uncovering biases, variances, and the overall effectiveness of the model in capturing the underlying patterns of the data.

In an embodiment, evaluation and tuning module 1428 performs continuous model tuning by using hyperparameter optimization. Evaluation and tuning module 1428 performs an exploration of the hyperparameter space using algorithms, such as grid search, random search, or more sophisticated methods like Bayesian optimization. Evaluation and tuning module 1428 uses these algorithms to iteratively adjust and refine the model's hyperparameters - settings that govern the model's learning process but are not directly learned from the data - to enhance the model's performance. This tuning process helps to balance the model's complexity with the model's ability to generalize and attempts to avoid the pitfalls of underfitting or overfitting.

In an embodiment, evaluation and tuning module 1428 integrates data feedback and updates the model. Evaluation and tuning module 1428 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, feedback might involve analyzing the model's prediction errors, misclassifications, or other performance metrics in live environments.

In an embodiment, feedback integration logic within evaluation and tuning module 1428 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining the model's previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 1428 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 1430 transforms data raw data into actionable, precise, and contextually relevant predictions. In addition to processing and applying a trained model to new data, inference module 1430 may also include post-processing logic that refines the raw outputs of the model into meaningful insights.

In an embodiment, inference module 1430 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 1430 transforms the outputs of a trained model into definitive classifications. Inference module 1430 employs the underlying model as a tool to generate probabilistic outputs for each potential class. Inference module 1430 then engages in an interpretative process to convert these probabilities into concrete class labels.

In an embodiment, when inference module 1430 receives the probabilistic outputs from the model, inference module 1430 analyzes these probabilities to determine how they are distributed across some or every potential class. If the highest probability is not significantly greater than the others, inference module 1430 may determine that there is ambiguity or interpret this as a lack of confidence displayed by the model.

In an embodiment, inference module 1430 uses thresholding techniques for applications where making a definitive decision based on the highest probability might not suffice due to the critical nature of the decision. In such cases, inference module 1430 assesses if the highest probability surpasses a certain confidence threshold that is predetermined based on the specific requirements of the application. If the probabilities do not meet this threshold, inference module 1430 may flag the result as uncertain or defer the decision to a human expert. Inference module 1430 dynamically adjusts the decision thresholds based on the sensitivity and specificity requirements of the application, subject to calibration for balancing the trade-offs between false positives and false negatives.

In accordance with an embodiment, inference module 1430 contextualizes the probability distribution against the backdrop of the specific application. This involves a comparative analysis, especially in instances where multiple classes have similar probability scores, to deduce the most plausible classification. In an embodiment, inference module 1430 may incorporate additional decision-making rules or contextual information to guide this analysis, ensuring that the classification aligns with the practical and contextual nuances of the application.

In regression models, where the outputs are continuous values, inference module 1430 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 1430 incorporates domain-specific adjustments into the post-processing routine. This involves tailoring the model's output to align with specific industry knowledge or contextual information. For example, in financial forecasting, inference module 1430 may adjust predictions based on current market trends, economic indicators, or recent significant events, ensuring that the outputs are both statistically accurate and practically relevant.

In an embodiment, inference module 1430 includes logic to handle uncertainty and ambiguity in the model's predictions. In cases where inference module 1430 outputs a measure of uncertainty, such as in Bayesian inference models, inference module 1430 interprets these uncertainty measures by converting probabilistic distributions or confidence intervals into a format that can be easily understood and acted upon. This provides users with both a prediction and an insight into the confidence level of that prediction. In an embodiment, inference module 1430 includes mechanisms for involving human oversight or integrating the instance into a feedback loop for subsequent analysis and model refinement.

In an embodiment, inference module 1430 formats the final predictions for end-user consumption. Predictions are converted into visualizations, user-friendly reports, or interactive interfaces. In some systems, like recommendation engines, inference module 1430 also integrates feedback mechanisms, where user responses to the predictions are used to continually refine and improve the model, creating a dynamic, self-improving system.

FIG. 15 illustrates the operation of a machine learning engine in accordance with one or more embodiments. In an embodiment, the system receives a dataset intended for training (Operation 1501). This data can originate from diverse sources, like databases or real-time data streams, and in varied formats, such as CSV, JSON, or XML. The system assesses and validates the data, ensuring the data's integrity by checking for consistency, data ranges, and types. In one embodiment, this operation is performed by an input/output module as described above in reference to FIG. 14.

In an embodiment, the system preprocesses training data. Here, the data undergoes a series of transformations to standardize and clean the data, making the transformed data suitable for training ML models (Operation 1502). This involves normalizing numerical data, encoding categorical variables, and handling missing values through techniques like imputation. In one embodiment, this operation is performed by a preprocessing data module as described above in reference to FIG. 14.

In an embodiment, the system selects a model from the prepared data (Operation 1503). The system analyzes the characteristics of the processed data, such as dimensionality and distribution, and selects the most appropriate model architecture for the given dataset and problem. The system employs statistical and analytical techniques to match the data with an optimal model, ranging from simpler models for less complex tasks to more advanced architectures for intricate tasks. In one embodiment, this operation is performed by a model selection module as described above in reference to FIG. 14.

In an embodiment, the system trains the selected model with the prepared dataset (Operation 1504). The system implements learning algorithms to adjust the model's internal parameters, optimizing them to identify patterns and relationships in the training data. The system also addresses the challenge of overfitting by implementing techniques, like regularization and early stopping, ensuring the model's generalizability. In one embodiment, this operation is performed by a training module as described above in reference to FIG. 14.

In an embodiment, the system evaluates the trained model's performance using the validation dataset (Operation 1505). The system applies various metrics to assess predictive accuracy and generalization capabilities. The system then tunes the model by adjusting hyperparameters, and if needed, incorporates feedback from the model's initial deployments, retraining the model with new data patterns identified from the feedback. In one embodiment, this operation is performed by an evaluation and tuning module as described above in reference to FIG. 14.

In an embodiment, the system receives a dataset intended for inference. The system assesses and validates the data (Operation 1506). In one embodiment, this operation is performed by an input/output module as described above in reference to FIG. 14.

In an embodiment, the system receives the validated dataset intended for inference (Operation 1507). The system ensures that the data format used in training is replicated for the new inference data, maintaining consistency and accuracy for the model's predictions. In one embodiment, this operation is performed by a data preprocessing module as described above in reference to FIG. 14.

In an embodiment, the system processes the new data set intended for inference, using the trained and tuned model (Operation 1508). The system applies the model to this data, generating raw probabilistic outputs for predictions. The system then executes a series of post-processing steps on these outputs, such as converting probabilities to class labels in classification tasks or rescaling values in regression tasks. The system contextualizes the outputs as per the application's requirements, handling any uncertainty in predictions and formatting the final outputs for end-user consumption or integration into larger systems. In one embodiment, this operation is performed by an inference module as described above in reference to FIG. 14.

### 9. Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module $20, when used for large language models, handles textual data, converting input text into a format that the model can process. This typically involves tokenization, where the text is broken down into manageable pieces, such as words or sub-words, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module $22 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module $24, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module $26, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that the detail and noise negatively impact the model's performance on new data).

In accordance with one or more embodiments, evaluation and tuning module $28 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module $30, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for having the ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. The self-attention mechanism enables the model to weigh the importance of different elements within an input sequence, regardless of their position, allowing the model to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing the model's ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making the model a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, the list illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 10. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form that such claims issue, including any subsequent correction.

What is claimed is:

1. A method comprising:
generating a target layout polygon representing a floor area of a physical environment;
generating a set of obstacle polygons, wherein an obstacle polygon (a) represents a physical obstacle present in the physical environment, (b) has dimensions corresponding to dimensions of a physical obstacle footprint, (c) and has a position within the target layout polygon;
generating a set of pod polygons, wherein a pod polygon (a) represents a physical pod and (b) has dimensions corresponding to dimensions of a physical pod footprint;
executing a positioning algorithm to generate a first initial layout, the positioning algorithm comprising:
identifying the target layout polygon as a current layout polygon;
iteratively performing a first set of operations until an occurrence of a terminating event, the first set of operations comprising:
placing a pod polygon, from an unplaced subset of the set of pod polygons, into an initial position within the current layout polygon;
dividing a remaining footprint of the current layout polygon into one or more additional layout polygons; and
identifying another layout polygon as the current layout polygon;
generating the first initial layout comprising positioning information indicating the initial positions of the set of pod polygons within the target layout polygon;
executing a collision avoidance algorithm that modifies the first initial layout to generate an updated layout, the collision avoidance algorithm comprising:
identifying a first obstacle polygon, from the set of obstacle polygons, as a current obstacle polygon;
iteratively performing a second set of operations until the set of obstacle polygons is processed, the second set of operations comprising:
determining whether a collision exists between the current obstacle polygon and any of the set of pod polygons placed into the initial layout;
responsive at least to determining the collision exists:
identifying a subset of one or more pod polygons associated with the collision as a set of colliding pod polygons;
based on the initial positions of the set of colliding pod polygons, determining updated positions of the set of colliding pod polygons to avoid the collision; and
placing the colliding pod polygons into the updated positions within the target layout polygon;
identifying another obstacle polygon, from the set of obstacle polygons, as the current obstacle polygon; and
generating the updated layout comprising positioning information indicating updated positions of the set of pod polygons within the target layout polygon;
wherein the method is performed by at least one device including a hardware processor.

2. The method of claim 1, wherein the pod polygon placed into the initial position within the current layout polygon comprises a largest possible pod polygon, of the unplaced subset of the set of pod polygons, that fits within the current layout polygon.

3. The method of claim 1, wherein the pod polygon placed into the initial position within the current layout polygon comprises a pod polygon, of the unplaced subset of the set of pod polygons, that is larger than at least one other pod polygon of the unplaced subset of the set of pod polygons and that fits within the current layout polygon.

4. The method of claim 1, wherein the updated layout comprises positioning information indicating updated positions of a non-colliding subset of the set of rack polygons within the target layout polygon.

5. The method of claim 1, further comprising:
prior to determining updated positions of the set of colliding pod polygons, selecting a movement direction and a movement distance; and
subsequent to determining that the movement direction and the movement distance satisfy a movement constraint, determining the updated positions of the set of colliding pod polygons based on the movement distance in the movement direction within the target layout polygon.

6. The method of claim 5, wherein a movement constraint comprises one or more of: a permitted movement distance limit, a permitted proximity limit to a side of the target layout polygon, and a permitted proximity limit to a second subset of the set of pod polygons in the first initial layout that does not include the colliding pod polygons.

7. The method of claim 1, wherein the terminating event comprises terminating execution of the positioning algorithm when no pod polygons, of the unplaced subset of the set of pod polygons, can fit within any remaining layout polygons.

8. The method of claim 1, wherein the terminating event comprises terminating execution of the positioning algorithm when a cumulative power consumption of a set of physical pods, represented by the pod polygons in the first initial layout, meets a power threshold.

9. The method of claim 1, wherein the terminating event comprises terminating execution of the positioning algorithm when placing an additional pod polygon within the first initial layout would exceed a power threshold, based on a cumulative power consumption of a set of physical pods represented by the pod polygons in the first initial layout.

10. The method of claim 1, further comprising iteratively selecting an obstacle polygon from the set of obstacle polygons in the target layout polygon in an order based on the positions of the obstacle polygons in the target layout polygon.

11. The method of claim 1, further comprising:
determining, for the first initial layout, a first metric value based on one or more of: a number of pod polygons in the first initial layout, an amount of used area of the target layout polygon corresponding to a collective area occupied by the number of pod polygons in the first initial layout, and an amount of unused area of the target layout polygon corresponding to positions in the target layout polygon not occupied by a pod polygon;
executing the positioning algorithm to generate a second initial layout, wherein the pod polygons in the second initial layout are placed in the target layout polygon in an orientation that is orthogonal to an orientation of the pod polygons in the first initial layout;
determining, for the second initial layout, a second metric value based on one or more of: a number of pod polygons in the second initial layout, an amount of used area of the target layout polygon corresponding to a collective area occupied by the number of pod polygons in the second initial layout, and an amount of unused area of the target layout polygon corresponding to positions in the target layout polygon not occupied by a pod polygon;
selecting one of the first initial layout or the second initial layout based on the respective first metric value or second metric value; and
executing the collision avoidance algorithm on the selected layout.

12. The method of claim 1, further comprising: executing a basket tray placement algorithm to generate a basket tray path, the basket tray placement algorithm comprising:
generating a first path line, in the updated layout, that intersects a center portion of a set of aligned pod polygons; and
responsive to determining a collision of a first portion of the first path line and an obstacle polygon in the updated layout, diverting the first portion of the first path line away from the obstacle polygon with a first orthogonal turn on a first side of the obstacle polygon and a second opposing orthogonal turn on a second side of the obstacle polygon, wherein the diverted first portion of the first path line is parallel to a portion of the first path line that is not diverted.

13. The method of claim 1, further comprising:
using a training set comprising a plurality of existing layouts, training a machine learning model to generate an optimized layout of pod polygons in a layout polygon according to a set of constraints; and
applying the machine learning model to a layout polygon comprising a set of obstacle polygons, a set of pod polygons, and a set of constraints to generate the first initial layout.

14. The method of claim 1, further comprising:
using a training set comprising a plurality of existing layouts, training a machine learning model to select a first position in the target layout polygon for placing a first pod polygon;
wherein executing the positioning algorithm further comprises:
applying the machine learning model to a layout polygon comprising a set of obstacle polygons, a set of pod polygons, and a set of constraints to select a position for the first pod polygon.

15. A method comprising:
generating a target layout polygon representing a floor area of a physical environment;
generating a set of obstacle polygons, wherein an obstacle polygon (a) represents a physical obstacle present in the physical environment, (b) has dimensions corresponding to dimensions of a physical obstacle footprint, (c) and has a position within the target layout polygon;
generating a set of pod polygons, wherein a pod polygon (a) represents a physical pod, and (b) has dimensions corresponding to dimensions of a physical pod footprint;
generating a set of rack polygons, wherein a rack polygon (a) represents a physical rack within a physical pod, and (b) has dimensions corresponding to dimensions of a physical rack footprint;
executing a positioning algorithm to generate an initial layout, the positioning algorithm comprising:
identifying the target layout polygon as a current layout polygon;
iteratively performing a first set of operations until an occurrence of a terminating event, the first set of operations comprising:
placing a pod polygon, from an unplaced subset of the set of pod polygons, into an initial position within the current layout polygon;
dividing a remaining footprint of the current layout polygon into one or more additional layout polygons;
identifying another layout polygon as the current layout polygon;
generating the initial layout comprising positioning information indicating the initial positions of the set of pod polygons within the target layout polygon;
executing a collision avoidance algorithm that modifies the initial layout to generate an updated layout, the collision avoidance algorithm comprising:
identifying a first obstacle polygon, from the set of obstacle polygons, as a current obstacle polygon;
iteratively performing a second set of operations until the set of obstacle polygons are processed, the second set of operations comprising:
determining whether a collision exists between the current obstacle polygon and any of the set of pod polygons placed into the initial layout;
responsive at least to determining the collision exists:
identifying a subset of one or more pod polygons associated with the collision as a set of colliding pod polygons;
identifying a subset of rack polygons within the set of colliding pod polygons that collide with the current obstacle polygon;
generating removal information indicating that the subset of rack polygons is removed from the set of colliding pod polygons;
identifying another obstacle polygon, from the set of obstacle polygons, as the current obstacle polygon; and
generating the updated layout comprising (a) positioning information indicating updated positions of the set of pod polygons within the target layout polygon, and (b) the removal information indicating that the subset of rack polygons is removed from the set of colliding pod polygons, wherein the updated position of at least one of the set of pod polygons is the same as the initial position of at least one of the set of pod polygons;
wherein the method is performed by at least one device including a hardware processor.

16. The method of claim 15, wherein generating the removal information indicating that the subset of rack polygons is removed from the set of colliding pod polygons is subsequent to determining that the set of colliding pod polygons cannot be moved to remove the collision without violating a movement constraint.

17. The method of claim 16, wherein a movement constraint comprises one or more of: a permitted movement distance limit, a permitted proximity limit to a side of the target layout polygon, and a permitted proximity limit to a second subset of the set of pod polygons in the first initial layout that does not include the colliding pod polygons.

18. The method of claim 16, wherein determining that the set of colliding pod polygons cannot be moved to remove the collision without violating a movement constraint comprises:
iteratively executing a repositioning process comprising:
prior to moving the set of colliding pod polygons from an initial position, selecting a movement direction and a movement distance;
subsequent to determining that the movement direction and the movement distance satisfy a movement constraint, moving the set of colliding pod polygons by the movement distance in the movement direction; and
subsequent to moving the set of colliding pod polygons, determining that a collision between the current obstacle polygon and the set of colliding pod polygons still exists;
wherein the repositioning process is iterated until there are no remaining positions for moving the set of colliding pod polygons that satisfy the movement constraints.

19. The method of claim 18, further comprising: returning the set of colliding pod polygons to the initial position in the initial layout.

20. The method of claim 18, further comprising:
determining a second position for the set of colliding pod polygons that satisfies the movement constraint relative to the initial position in the initial layout and that reduces an amount of overlap between the current obstacle polygon and the set of colliding pod polygons relative to the initial position; and
placing the set of colliding pod polygons in the second position in the updated layout.
